(19) United States
(12) Patent Application Publication
(10) Pub. No.: US 2024/0411126 A1
(43) Pub. Date: Dec. 12, 2024

(54) DRIVING MECHANISM

(71) Applicant: TDK TAIWAN CORP., Taoyuan City (TW)

(72) Inventors: Yi-Ho CHEN, Taoyuan City (TW); Ling Yi KE, Taoyuan City (TW); Yu-Chiao LO, Taoyuan City (TW); Chao-Chang HU, Taoyuan City (TW)

(21) Appl. No.: 18/733,029

(22) Filed: Jun. 4, 2024

Related U.S. Application Data
(60) Provisional application No. 63/471,602, filed on Jun. 7, 2023.

(51) Int. Cl. G02B 26/08

(52) U.S. Cl. CPC G02B 26/0816

(57) ABSTRACT

A driving mechanism includes a fixed part, a movable part, and a driving assembly. The movable part is movably connected to the fixed part for holding an optical element that has an optical axis. The driving assembly is configured to drive the movable part to move relative to the fixed part.

### CROSS REFERENCE TO RELATED APPLICATIONS

This application claims the benefit of U.S. provisional application No. 63/471,602, filed Jun. 7, 2023, the entirety of which is incorporated by reference herein.

### BACKGROUND OF THE INVENTION

### Field of the Invention

The present invention relates to a driving mechanism, and, in particular, to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

Some electronic devices, such as Augmented Reality (AR) glasses, may have several coils and magnets for rotating a reflective mirror in the optical system. However, miniaturization of these electronic devices may increase the difficulty of mechanical design, and it may also lead to the small rotation range of the mirror and the low reliability of the driving mechanism. Therefore, addressing the aforementioned problems has become a challenge.

### BRIEF SUMMARY OF THE INVENTION

An embodiment of the present invention provides a driving mechanism that includes a fixed part, a movable part, and a driving assembly. The movable part is movably connected to the fixed part for holding an optical element that has an optical axis. The driving assembly is configured to drive the movable part to move relative to the fixed part.

In some embodiments, the driving mechanism further includes a circuit board connected to the fixed part, wherein the driving assembly has a magnetic element disposed on the movable part and a first coil disposed on the circuit board, wherein the first coil is wound around a first central axis that is not parallel to the optical axis.

In some embodiments, the driving assembly further has a second coil connected to the first coil and wound around a second central axis, wherein the second central axis is not parallel to the optical axis and the first central axis.

In some embodiments, the first and second central axes are perpendicular to each other.

In some embodiments, at least a part of the second coil is accommodated in the first coil.

In some embodiments, the center of the second coil is located between the magnetic element and the center of the first coil along the optical axis.

In some embodiments, the driving mechanism further includes a magnetic permeable element disposed in the second coil, wherein the center of the magnetic permeable element is located between the magnetic element and the center of the second coil along the optical axis.

In some embodiments, the circuit board forms a recess for receiving the first coil.

In some embodiments, the driving mechanism further includes a sensor disposed on the circuit board for detecting the displacement of the movable part relative to the fixed part.

In some embodiments, the sensor and the first coil are disposed on opposite sides of the circuit board, and the sensor is located between the first coil and the magnetic element along the optical axis.

In some embodiments, the driving mechanism further includes a plurality of sensors disposed on the circuit board for detecting the displacement of the movable part relative to the fixed part, wherein the sensors are arranged in a rotationally symmetric manner with respect to the optical axis.

In some embodiments, the sensors include a longitudinal first sensor and a longitudinal second sensor, and the first and second sensors at least partially overlap when viewed along a first long axis of the first sensor.

In some embodiments, the center of the second sensor is offset from the first long axis of the first sensor.

In some embodiments, the sensors further include a longitudinal third sensor, and the second and third sensors at least partially overlap when viewed along a second long axis of the second sensor.

In some embodiments, the first coil has a first upper portion and a first lower portion located on opposite sides of the first coil, and the second coil has a second upper portion and a second lower portion located on opposite sides of the second coil, wherein at least a part of the second coil is accommodated in the first coil, and the second upper portion of the second coil is adhered to the first upper portion of the first coil.

In some embodiments, the first upper portion is located between the magnetic element and the second upper portion, and the first lower portion is spaced apart from the second lower portion.

In some embodiments, the driving mechanism further includes a magnetic permeable element disposed in the second coil and adhered to the second upper portion. In some embodiments, the circuit board forms a first cavity, and when the movable part moves to a first limit position relative to the fixed part, a first portion of the movable part is received in the first cavity and contacts the circuit board.

In some embodiments, the circuit board further forms a second cavity, and when the movable part moves to a second limit position relative to the fixed part, a second portion of the movable part is received in the second cavity and contacts the circuit board.

In some embodiments, the driving mechanism further includes an electronic element disposed on the circuit board, wherein the electronic element alternately transmits a first current signal to the first coil and transmits a second current signal to the second coil for driving the movable part to move relative to the fixed part.

### BRIEF DESCRIPTION OF THE DRAWINGS

The present invention can be more fully understood by reading the subsequent detailed description and examples with references made to the accompanying drawings, wherein:

FIG. 1 shows an exploded view of a driving mechanism 100 in accordance with an embodiment of the invention.

FIG. 2 a perspective diagram of the driving mechanism 100 in FIG. 1 after assembly.

FIG. 3 shows another perspective diagram of the driving mechanism 100 in FIGS. 1 and 2 with the upper and lower housings H1 and H2 removed therefrom.

FIG. 4 shows a perspective diagram of the sensors HS1-HS4 disposed on the upper surface of the circuit board P.

FIG. 5 shows a partial enlarged top view of the sensors HS1-HS4 and the circuit board P.

FIG. 6 is a perspective diagram showing the sensor T disposed on the upper surface of the circuit board P, in accordance with another embodiment of the invention.

FIG. 7 shows a perspective diagram of the magnetic permeable element K and the first and second coils C1 and C2 on the bottom side of the circuit board P.

FIG. 8 shows an exploded view of the magnetic permeable element K, the first and second coils C1 and C2, the circuit board P, and the electronic element E.

FIG. 9 is a side view of the sensors HS1-HS4, the circuit board P, the electronic element E, the magnetic permeable element K, and the first and second coils C1 and C2 after assembly.

FIG. 10 is a schematic diagram showing the frame S when rotating around the second rotary axis R2 to a first limit position relative to the circuit board P.

FIG. 11 is a schematic diagram showing the frame S when rotating around the second rotary axis R2 to a second limit position relative to the circuit board P.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

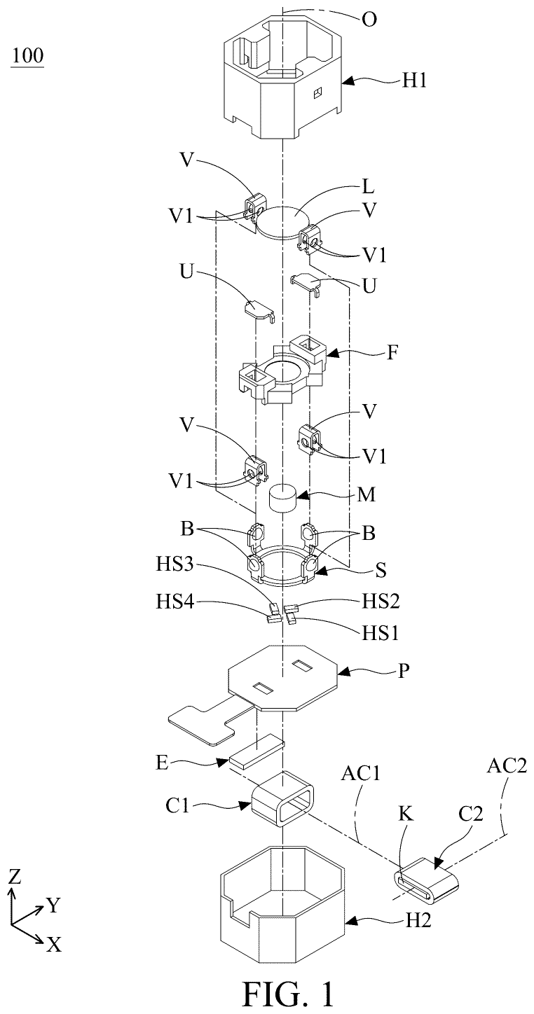

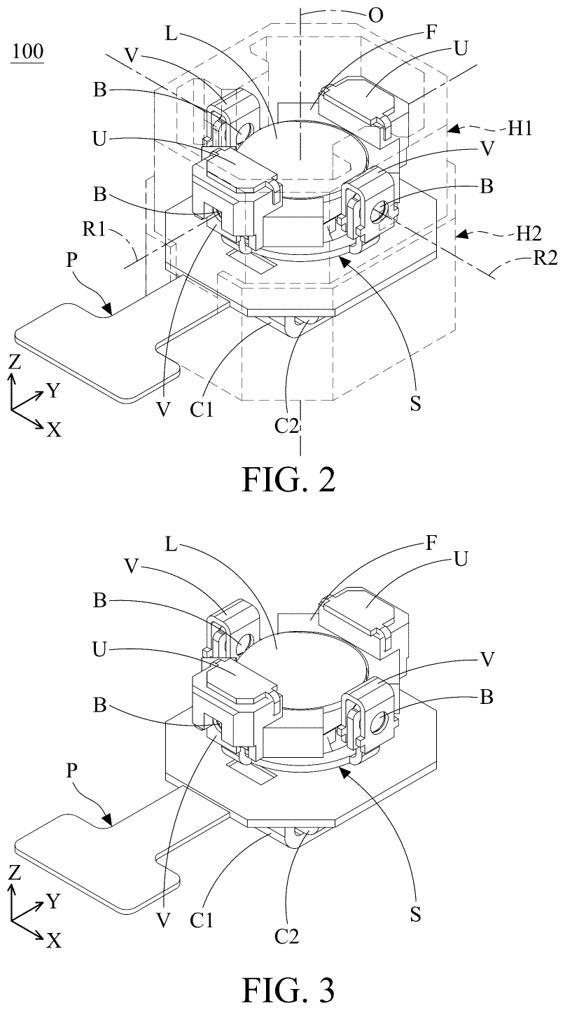

FIG. 1 shows an exploded view of a driving mechanism 100 in accordance with an embodiment of the invention. FIG. 2 a perspective diagram of the driving mechanism 100 in FIG. 1 after assembly. FIG. 3 shows another perspective diagram of the driving mechanism 100 in FIGS. 1 and 2 with the upper and lower housings H1 and H2 removed therefrom.

Referring to FIGS. 1-3, the driving mechanism 100 in this embodiment may be disposed in AR glasses, VR glasses, projectors or other portable electronic devices for driving an optical element L (e.g. reflecting mirror or optical lens) to move, wherein the optical element L has an optical axis O parallel to the Z direction.

The driving mechanism 100 primarily comprises an upper housing H1, a lower housing H2, a first coil C1, a second coil C2, a magnetic permeable element K disposed in the second coil C2, a circuit board P affixed to the upper housing H1, an electronic element E (e.g. IC element) disposed on the circuit board P, four sensors HS1-HS4, a frame S, four ball hinges B disposed on the frame S, a magnetic element M, four clips V, a holder F, and two caps U affixed to the frame S.

The upper housing H1 and the lower housing H2 are connected to each other and form a fixed part of the driving mechanism 100. The holder F and the frame S are movably received in the upper housing H1 and form a movable part of the driving mechanism 100.

The first coil C1 is wound around a first central axis AC1 that is parallel to the X direction, and the second coil C2 is wound around a second central axis AC2 that is parallel to the Y direction, wherein the optical axis O and the first and second coils C1 and C2 are perpendicular to each other. It should be noted that the first coil C1, the second coil C2, and the magnetic element M form a driving assembly of the mechanism 100 that can generate an electromagnetic force to drive the movable part (the holder F and the frame S) to move relative to the fixed part (the upper and lower housings H1 and H2).

In this embodiments, the optical element L is disposed on the upper surface of the holder F, and the magnetic element M (e.g. magnet) is disposed on the bottom surface of the holder F. It should be noted that the four ball hinges B are pivotally engaged in the holes V1 of the clips V. As shown in FIGS. 1-3, two of the clips V are affixed to the holder F and covered by the caps U, wherein the holder F, the optical element L, and the magnetic element M can rotate around a first rotary axis R1 relative to the frame S via two of the ball hinges B, and the first rotary axis R1 extends through two of the ball hinges B along the Y axis.

Additionally, the other two of the clips V are affixed to the upper housing H1, wherein the holder F and the frame S can rotate together around a second rotary axis R2 relative to the fixed part (the upper and lower housings H1 and H2). Here, the second rotary axis R2 extends through the other two of the ball hinges B along the X axis.

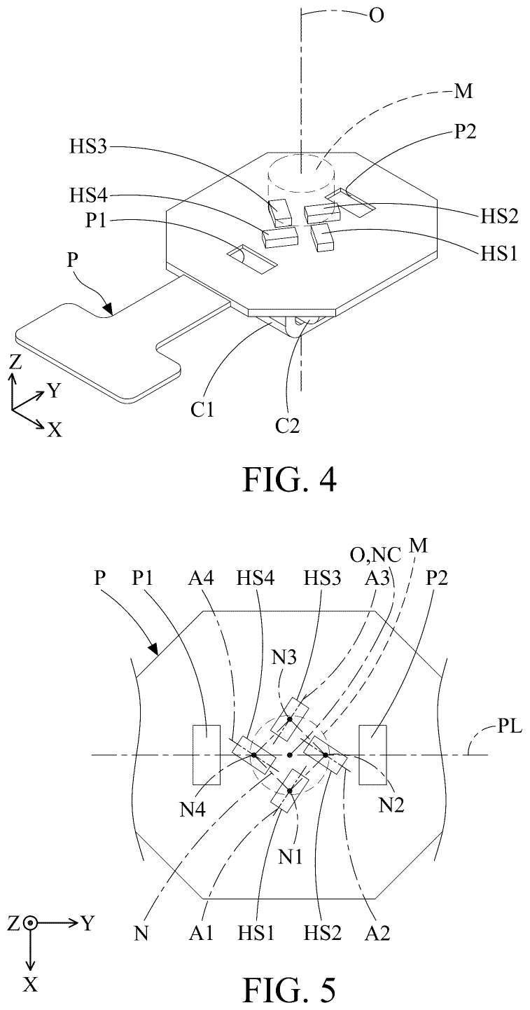

FIG. 4 shows a perspective diagram of the sensors HS1-HS4 disposed on the upper surface of the circuit board P. FIG. 5 shows a partial enlarged top view of the sensors HS1-HS4 and the circuit board P.

Referring to FIGS. 4 and 5, the four longitudinal sensors HS1-HS4 may be magnetic field sensors that are located close to the magnetic element M on the bottom surface of the holder F. In some embodiments, the sensors HS1-HS4 may comprise Hall effect sensors, MR sensors, or Fluxgate sensors to detect the positional variation of the magnetic element M, whereby the tilt angle and displacement of the holder F, the optical element L and the magnetic element M relative to the fixed part (the upper and lower housings H1 and H2) can be determined. Here, the sensors HS1-HS4 and the first and second coils C1 and C2 are electrically connected to the electronic element E via the circuit board P.

It should be noted that the sensors HS1-HS4 are arranged in a rotationally symmetric manner with respect to the optical axis O of the optical element L. Moreover, two cavities P1 and P2 are formed on the upper surface of the holder F, wherein a line PL extends through the center of each of the cavities P1 and P2 and intersects with the optical axis O (FIG. 5).

As shown in FIG. 5, the centers N1-N4 of the sensors HS1-HS4 define a polygonal shape N (square shape), and the central point NC of the polygonal shape overlap the magnetic element M when viewed along the optical axis O (Z direction). In this embodiment, the central point NC is located on the optical axis O of the optical element L and aligned to the center of the optical element L when viewed along the optical axis O (Z direction).

Here, all the centers N1-N4 of the four sensors HS1-HS4 overlap the magnetic element M when viewed along the optical axis O (Z direction). That is, the polygonal shape N is entirely covered by the magnetic element M when viewed along the optical axis O (FIG. 5). Specifically, the long axes A1-A4 of the sensors HS1-HS4 are angled relative to the sides of the polygonal shape N.

It should be noted that when viewed along the long axis A1 (first long axis) of the sensor HS1, the sensor HS1 (first sensor) and the sensor HS2 (second sensor) at least partially overlap, and the center of the sensor HS2 is offset from the long axis A1 of the sensor HS1. Similarly, when viewed along the long axis A2 (second long axis) of the sensor HS2, the sensor HS2 (second sensor) and the sensor HS3 (third sensor) at least partially overlap, and the center of the sensor HS3 is offset from the long axis A2 of the sensor HS2. In this embodiment, the sensors HS1-HS4 are arranged like windmill blades in a rotationally symmetric manner with respect to the optical axis O of the optical element L. Additionally, when viewed along a horizontal direction that is perpendicular to the optical axis O, the sensors HS1-HS4 are located between the first coil C and the magnetic element M.

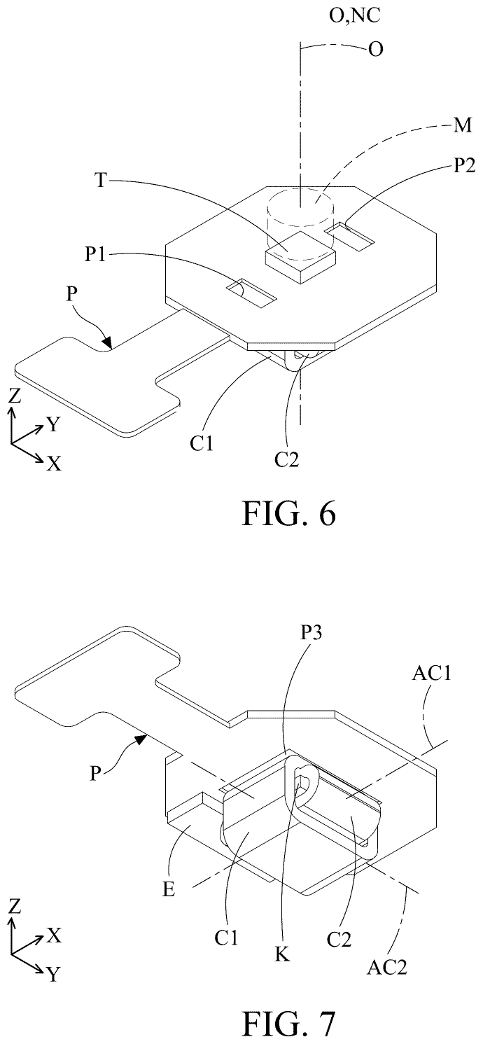

FIG. 6 is a perspective diagram showing the sensor T disposed on the upper surface of the circuit board P, in accordance with another embodiment of the invention. Referring to FIG. 6, the sensors HS1-HS4 in FIGS. 4 and 5 may be replaced by the sensor T that is disposed on the circuit board P and aligned with the center of the magnetic element M. In this embodiment, the sensor T may comprise a tunnel magnetoresistance (TMR) sensor to detect the tilt angle and displacement of the holder F, the optical element L and the magnetic element M relative to the fixed part (the upper and lower housings H1 and H2).

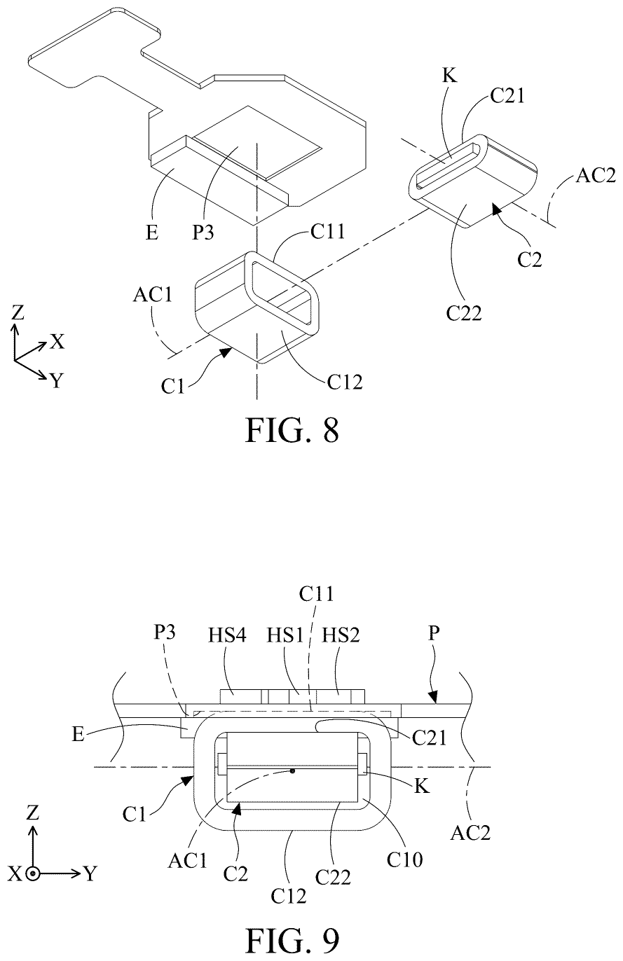

FIG. 7 shows a perspective diagram of the magnetic permeable element K and the first and second coils C1 and C2 on the bottom side of the circuit board P. FIG. 8 shows an exploded view of the magnetic permeable element K, the first and second coils C1 and C2, the circuit board P, and the electronic element E. FIG. 9 is a side view of the sensors HS1-HS4, the circuit board P, the electronic element E, the magnetic permeable element K, and the first and second coils C1 and C2 after assembly.

Referring to FIGS. 7-9, a recess P3 is formed on the bottom surface of the circuit board P. The first coil C1 has a first upper portion C11 and a first lower portion C12 located on opposite sides of the first coil C1. The second coil C2 has a second upper portion C21 and a second lower portion C22 located on opposite sides of the second coil C2, wherein the magnetic permeable element K is accommodated in the second coil C2 and adhered to the second upper portion C21. It should be noted that the first upper portion C11 is located between the magnetic element M and the second upper portion C21, and the first lower portion C12 may be spaced apart from the second lower portion C22 after assembly (FIG. 9).

As shown in FIG. 9, a part of the first upper portion C11 is accommodated in the recess P3 and adhered to the circuit board P by the glue, wherein the second upper portion C21 is disposed in first coil C1 and located between the first upper portion C11 and the first lower portion C12. Here, the second upper portion C21 of the second coil C2 is adhered to the first upper portion C11 of the first coil C1 by the glue.

In this configuration, when viewed along the first central axis AC1 of the first coil C1 (FIG. 9), the center of the second coil C2 is located between the magnetic element M and the center of the first coil C1, and the center of the magnetic permeable element K is located between the magnetic element M and the second coil C2. Therefore, miniaturization and high performance of the driving mechanism 100 can be achieved.

Still referring to FIGS. 7-9, the electronic element E on the bottom side of the circuit board P may comprise a controller that can be used to receive the sensing signals from the sensors HS1-HS4. The electronic element E can transmit current signals to the first coil C1 and the second coil C2 according to the sensing signals from the sensors HS1-HS4, thereby driving the holder F and the optical element L to rotate around the first rotary axis R1 or the second rotary axis R2 relative to the fixed part (the upper and lower housings H1 and H2).

In this embodiment, the electronic element E may alternately transmit a first current signal to the first coil C1 and transmit a second current signal to the second coil C2 at about 1 M Hz. That is, the electronic element E would not transmit current signals to the first coil C1 and the second coil C2 at the same time, thereby preventing electromagnetic interference between the first and second coils C1 and C2 and facilitating high reliability of the driving mechanism 100.

For example, when the electronic element E transmits a first current signal to the first coil C1, a first electromagnetic force is generated between the first coil C1 and the magnetic element M, whereby the optical element L and the magnetic element M can be driven to rotate around the first rotary axis R1 relative to the frame S.

Additionally, when the electronic element E transmits a second current signal to the second coil C2, a second electromagnetic force is generated between the second coil C2 and the magnetic element M, whereby the holder F and the frame S can be driven to rotate together around the second rotary axis R2 relative to the fixed part (the upper and lower housings H1 and H2).

In some embodiments, an external equipment (not shown) may be used to measure the positional deviation of the holder F, the optical element L and the magnetic element M relative to the fixed part (the upper and lower housings H1 and H2) when the electronic element E transmits current signals to the first coil C1 and the second coil C2 at the same time. Thus, compensation data can be generated to compensate the error caused by the electromagnetic interference between the first and second coils C1 and C2.

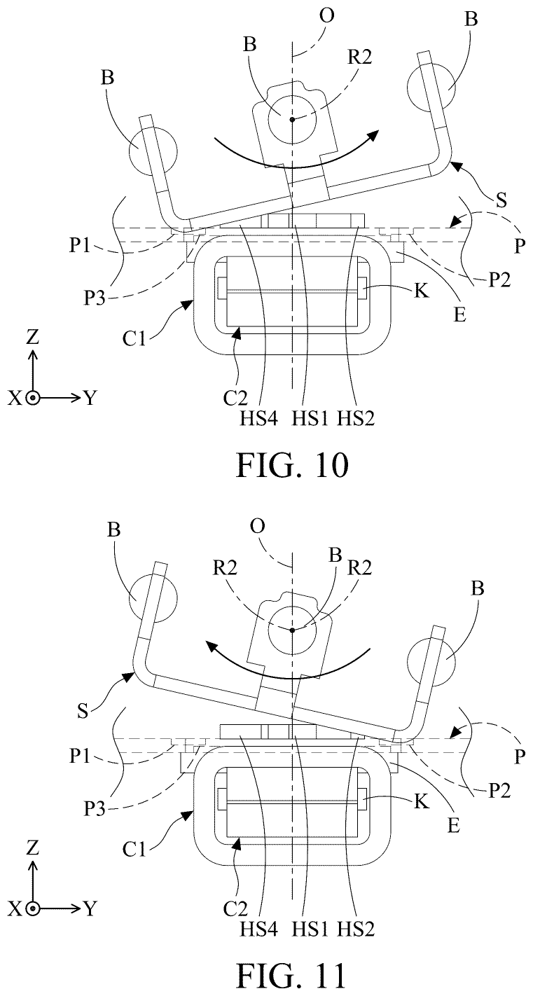

FIG. 10 is a schematic diagram showing the frame S when rotating around the second rotary axis R2 to a first limit position relative to the circuit board P. FIG. 11 is a schematic diagram showing the frame S when rotating around the second rotary axis R2 to a second limit position relative to the circuit board P.

As described above, when the electronic element E transmits a second current signal to the second coil C2, the frame S can be driven to rotate around the second rotary axis R2 to a first limit position with respect to the circuit board P and the fixed part (the upper and lower housings H1 and H2). In this state, a first portion of the frame S is received in the cavity P1 (first cavity) and contacts the circuit board P, as shown in FIG. 10.

Similarly, as shown in FIG. 11, when the electronic element E transmits a third current signal to the second coil C2 that is opposite to the second signal, the frame S can be driven to rotate around the second rotary axis R2 to a second limit position with respect to the circuit board P and the fixed part. In this state, a second portion of the frame S is received in the cavity P2 (second cavity) and contacts the circuit board P.

With the configuration, the rotation range of the movable part (the holder F and the frame S) can be increased, and miniaturization of the driving mechanism 100 can also be achieved.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

1. A driving mechanism, comprising:
a fixed part;
a movable part, movably connected to the fixed part for holding an optical element that has an optical axis; and
a driving assembly, configured to impel the movable part relative to the fixed part.

2. The driving mechanism as claimed in claim 1, further comprising a circuit board connected to the fixed part, wherein the driving assembly has a magnetic element disposed on the movable part and a first coil disposed on the circuit board, wherein the first coil is wound around a first central axis that is not parallel to the optical axis.

3. The driving mechanism as claimed in claim 2, wherein the driving assembly further has a second coil connected to the first coil and wound around a second central axis, wherein the second central axis is not parallel to the optical axis and the first central axis.

4. The driving mechanism as claimed in claim 3, wherein the first and second central axes are perpendicular to each other.

5. The driving mechanism as claimed in claim 3, wherein at least a part of the second coil is accommodated in the first coil.

6. The driving mechanism as claimed in claim 5, wherein the center of the second coil is located between the magnetic element and the center of the first coil along the optical axis.

7. The driving mechanism as claimed in claim 5, further comprising a magnetic permeable element disposed in the second coil, wherein the center of the magnetic permeable element is located between the magnetic element and the center of the second coil along the optical axis.

8. The driving mechanism as claimed in claim 3, wherein the circuit board forms a recess for receiving the first coil.

9. The driving mechanism as claimed in claim 3, further comprising a sensor disposed on the circuit board for detecting the displacement of the movable part relative to the fixed part.

10. The driving mechanism as claimed in claim 9, wherein the sensor and the first coil are disposed on opposite sides of the circuit board, and the sensor is located between the first coil and the magnetic element along the optical axis.

11. The driving mechanism as claimed in claim 3, further comprising a plurality of sensors disposed on the circuit board for detecting the displacement of the movable part relative to the fixed part.

12. The driving mechanism as claimed in claim 11, wherein the sensors include a longitudinal first sensor and a longitudinal second sensor, and the first and second sensors at least partially overlap when viewed along a first long axis of the first sensor.

13. The driving mechanism as claimed in claim 12, wherein the center of the second sensor is offset from the first long axis of the first sensor.

14. The driving mechanism as claimed in claim 12, wherein the sensors further include a longitudinal third sensor, and the second and third sensors at least partially overlap when viewed along a second long axis of the second sensor.

15. The driving mechanism as claimed in claim 3, wherein the first coil has a first upper portion and a first lower portion located on opposite sides of the first coil along the optical axis, and the second coil has a second upper portion and a second lower portion located on opposite sides of the second coil along the optical axis, wherein at least a part of the second coil is accommodated in and adhered to the first coil.

16. The driving mechanism as claimed in claim 15, wherein the first upper portion is located between the magnetic element and the second upper portion, and the first lower portion is spaced apart from the second lower portion.

17. The driving mechanism as claimed in claim 15, further comprising a magnetic permeable element disposed in the second coil and adhered to the second upper portion.

18. The driving mechanism as claimed in claim 3, wherein the circuit board forms a first cavity, and when the movable part moves to a first limit position relative to the fixed part, a first portion of the movable part is received in the first cavity.

19. The driving mechanism as claimed in claim 18, wherein the circuit board further forms a second cavity, and when the movable part moves to a second limit position relative to the fixed part, a second portion of the movable part is received in the second cavity.

20. The driving mechanism as claimed in claim 3, further comprising an electronic element disposed on the circuit board, wherein the electronic element alternately transmits a first current signal to the first coil and transmits a second current signal to the second coil for driving the movable part to move relative to the fixed part.

21. The driving mechanism as claimed in claim 3, further comprising a plurality of sensors disposed on the circuit board for detecting the displacement of the movable part relative to the fixed part, wherein the sensors are arranged in a rotational symmetric manner with respect to the optical axis.

22. The driving mechanism as claimed in claim 3, wherein the first coil has a first upper portion and a first lower portion located on opposite sides of the first coil along the optical axis, and the second coil has a second upper portion and a second lower portion located on opposite sides of the second coil along the optical axis, wherein at least a part of the second coil is accommodated in the first coil, and the second upper portion of the second coil is adhered to the first upper portion of the first coil.
